(19) United States
(12) Patent Application Publication
(10) Pub. No.: US 2023/0041288 A1
(43) Pub. Date: Feb. 9, 2023

(54) LIDAR FOR SHORT RANGE AND LONG RANGE USING SINGLE LIGHT SOURCE

(71) Applicant: HL KLEMOVE CORP., Incheon (KR)

(72) Inventors: Yun Ki HAN, Gyeonggi-do (KR); HoSeok SHIN, Gyeonggi-do (KR); Hyuk RYU, Seoul (KR); Hak Gu HAN, Gyeonggi-do (KR); Chulseung LEE, Gyeonggi-do (KR); Yongmin PARK, Gyeonggi-do (KR)

(21) Appl. No.: 17/877,884

(22) Filed: Jul. 30, 2022

(30) Foreign Application Priority Data
Jul. 30, 2021 (KR) 10-2021-0101009

(51) Int. Cl. G01S 17/931; G01S 17/08; G01S 7/481

(52) U.S. Cl. CPC G01S 17/931; G01S 17/08; G01S 7/4816

(57) ABSTRACT

Disclosed are a light detection and ranging (LIDAR) for both short range and long range based on a single light source, and a vehicle including the same. The lidar includes: a transmitter configured to generate and transmit light; a first receiver configured to receive light reflected from an object within a first detection region of a short range; and a second receiver configured to receive light reflected from an object within a second detection region of a long range, wherein a two-dimensional region of the second detection region at least partially overlapping the first detection region is included in the first detection region.

### CROSS REFERENCE TO RELATED APPLICATION

The present application claims priority to Korean Patent Application No. 10-2021-0101009, filed Jul. 30, 2021, the entire contents of which is incorporated herein for all purposes by this reference.

### BACKGROUND OF THE INVENTION

### Field of the Invention

The disclosure relates to a light detection and ranging (LIDAR) technology and, more particularly, to lidar technology for both short and long ranges based on a single light source.

### Description of the Related Art

With the recent intellectualization of vehicles, research on autonomous vehicles, advanced driver assistance systems (ADAS), etc., have been actively conducted.

FIG. 1 shows an example of the detection ranges of various sensors applied to a vehicle.

Various sensors are required to realize the autonomous vehicles, the advanced driver assistance systems. As shown in FIG. 1, such sensors include radio detection and ranging (RADAR), light detection and ranging (LIDAR), a camera, an ultrasound sensor, etc. In particular, the lidar has a relatively low accuracy of identifying an object but has the advantage of obtaining accurate distance information, thereby being used as mounted to the front and back of most autonomous vehicles.

Meanwhile, the lidar mounted to the vehicle includes a transmitter for generating and transmitting light to an object, a receiver for receiving the light reflected from the object, and a signal processor for processing signals related to the light of the transmitter and the receiver. Of course, the transmitter and the receiver include an optical system that controls a path through which the transmitted and received light passes. In this case, when each detection region of the transmitter and the receiver is in a short range, a relatively wide field of view (FOV) and a relatively low resolution are required (hereinafter referred to as a “first requirement”). On the other hand, when the detection region is in a long range, a relatively narrow FOV and a high resolution are required (hereinafter referred to as a “second requirement”).

Conventionally, a plurality of lidars has been used to meet these requirements. In other words, a first lidar for satisfying the first requirement and a second lidar for satisfying the second requirement are mounted to the vehicle. The first and second lidars in the related art are configured to use different light sources, each individually including the transmitter and the receiver. Therefore, such related art has problems of a complicated structure and high manufacturing costs.

Meanwhile, there may be other related arts for satisfying both the wide FOV and the high resolution with regard to all regions, i.e., regardless of whether the detection region is in the short range or the long range. However, it is impossible for these related arts to achieve high performance required for a detector of the receiver, etc.

The above information disclosed in this Background section is only for enhancement of understanding of the background of the invention and it may therefore contain information that does not form the prior art that is already known to a person of ordinary skill in the art.

### SUMMARY OF THE INVENTION

An aspect of the disclosure is to provide a lidar applicable for both short and long ranges based on a single light source.

Problems to be solved in the disclosure are not limited to the forementioned problems, and other unmentioned problems can be clearly understood from the following description by a person having ordinary knowledge in the art to which the disclosure pertains.

According to an embodiment of the disclosure, light detection and ranging (lidar) for detecting outside of a vehicle includes: a transmitter configured to generate and transmit light; a first receiver configured to receive light reflected from an object within a first detection region of a short-range; and a second receiver configured to receive light reflected from an object within a second detection region of a long-range.

A two-dimensional region of the second detection region projected at least partially overlapping the first detection region may be included in the first detection region.

In a non-scanning type, the transmitter may transmit light in a range of vertical and horizontal divergence angles with regard to a region of a short range, the first receiver may include a two-dimensional detection unit to receive the light transmitted in the range of the vertical and horizontal divergence angles with regard to the region of the short range and reflected from an object in a short range, and the second receiver may include a two-dimensional detection unit to receive light transmitted in a narrower range of vertical and horizontal divergence angles and reflected from an object in a long range, of the light transmitted in the range of the vertical and horizontal divergence angles with respect to the short range region.

The transmitter may transmit light having vertical and horizontal divergence angles wider than or equal to the vertical and horizontal fields of view (FOV) of the first receiver.

The first receiver may have wider vertical and horizontal fields of view and a lower resolution than the second receiver.

In a scanning type, the transmitter may transmit light in a range of vertical divergence angle about a region of a short range while performing scanning in a horizontal direction, the first receiver may include a one-dimensional detection unit to receive the light transmitted in the range of the vertical divergence angle with regard to the region of the short range and reflected from an object in a short range, and the second receiver may include a one-dimensional detection unit to receive light transmitted in a narrower range of a vertical divergence angle and reflected from an object in a long range, of the light transmitted in the range of the vertical divergence angle with regard to the region of the short range.

The transmitter may transmit light having a vertical divergence angle wider than or equal to a vertical field of view (FOV) of the first receiver.

The first receiver may have a wider vertical field of view and a lower resolution than the second receiver.

The second receiver may perform detection in a shorter time cycle than the first receiver to increase a horizontal resolution.

The second receiver may adjust the position or angle of a lens thereof to change the second detection region.

According to an embodiment of the disclosure, a vehicle includes a light detection and ranging (lidar) for detecting an outside, the lidar including: a transmitter configured to generate and transmit light; a first receiver configured to receive light reflected from an object within a first detection region of a short range; and a second receiver configured to receive light reflected from an object within a second detection region of a long range, wherein a two-dimensional region of the second detection region at least partially overlapping the first detection region is included in the first detection region.

The lidar may be configured to detect an object located in front, back or lateral sides of the vehicle.

The vehicle may include an autonomous vehicle or a vehicle with an advanced driver assistance system (ADAS).

With the foregoing configurations according to the disclosure, a single light source is used for both short range and long range, and one transmitter is used, thereby having an advantage of low manufacturing costs.

Further, according to the disclosure, a plurality of receivers are used for one transmitter 100, so that a plurality of regions can be detected with various specifications, and in particular, a detection region for a long range can be changed, thereby having an advantage of being free to select an appropriate operation as necessary.

Further, according to the disclosure, a zoom function may be appliable to the second receiver, and, in addition to the zoom function, other functions may be implemented to align the second receiver or its lens, which are misaligned by various factors during operation, for direction calibration, or intentionally change the angle of the second receiver or its lens, thereby having advantages in that the position change of the second detection region and the change in the detection range for the second detection region are possible.

Effects obtainable from the disclosure may not be limited by the aforementioned effects, and other unmentioned effects can be clearly understood from the following description by a person having ordinary knowledge in the art to which the present invention pertains.

### BRIEF DESCRIPTION OF THE DRAWINGS

FIG. 1 shows an example of the detection ranges of various sensors applied to a vehicle.

FIG. 2 is a block diagram of a lidar 1000 according to an embodiment of the disclosure.

FIG. 3 shows an example of detection regions DR1 and DR2 of a non-scanning type lidar 1000 according to an embodiment of the disclosure.

FIG. 4 shows the detection regions DR1 and DR2 of FIG. 3, viewed in a horizontal direction.

FIG. 5 shows the detection regions DR1 and DR2 of FIG. 3, viewed in a vertical direction.

FIG. 6 shows an example of detection regions DR1 and DR2 of a scanning type lidar 1000 according to an embodiment of the disclosure.

FIG. 7 shows the detection regions DR1 and DR2 of FIG. 6, viewed in a horizontal direction.

FIG. 8 shows the detection regions DR1 and DR2 of FIG. 6, viewed in a vertical direction.

FIG. 9 shows an example of lenses of a first receiver 200 and their optical paths in a non-scanning type lidar 1000 according to an embodiment of the disclosure.

FIG. 10 shows an example of lenses of a second receiver 300 and their optical paths in a non-scanning type lidar 1000 according to an embodiment of the disclosure.

FIG. 11 shows an example of lenses of a first receiver 200 and their optical paths in a scanning type lidar 1000 according to an embodiment of the disclosure.

FIG. 12 shows an example of lenses of a second receiver 300 and their optical paths in a scanning type lidar 1000 according to an embodiment of the disclosure.

FIG. 13 is a block diagram of a second receiver 300 with a movable lens.

FIG. 14 is a block diagram of a movable second receiver 300.

FIG. 15 shows an example of the movement of a second receiver 300 or its lens 310.

FIG. 16 shows an example of the movement of a second receiver 300 or its lens 310 in a light entering direction D1.

FIG. 17 shows an example of movement of a second receiver 300 or its lens 310 in an opposite direction D2 to the light receiving direction D1.

FIG. 18 shows an example of a configuration of a second receiver 300 with a lens that is not only movable but also changeable in angle.

FIG. 19 shows an example of a scanning type scanning lidar.

FIG. 20 shows an example of a non-scanning type flash lidar.

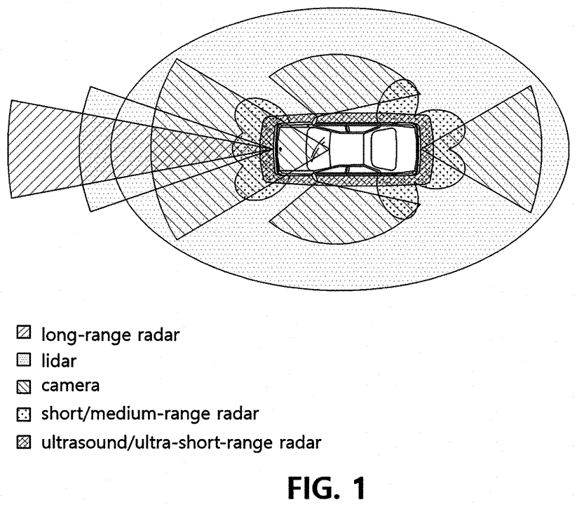

### DETAILED DESCRIPTION OF THE INVENTION

The above-described objects and means of the disclosure and the effects associated therewith will become more apparent through the following detailed description in conjunction with the accompanying drawings. Accordingly, a person having ordinary knowledge in the art to which the disclosure pertains can readily implement the technical spirit of the disclosure. In addition, when it is determined that detailed descriptions of related well-known functions unnecessarily obscure the gist of the disclosure during the description of the disclosure, the detailed descriptions thereof will be omitted.

Terms used herein are for the purpose of describing embodiments only and are not intended to limit the disclosure. In the present specification, the singular forms are intended to include the plural forms as well in some cases, unless the context clearly indicates otherwise. In the present specification, terms such as “comprise,” “include,” “prepare,” or “have” do not preclude the presence or addition of one or more other components other than the components mentioned.

In the present specification, terms such as “or,” “at least one,” and the like may represent one of the words listed together, or may represent a combination of two or more. For example, “A or B” and “at least one of A and B” may include only one of A or B and may include both A and B.

In the present specification, descriptions following “for example” may not exactly match the information presented, such as cited characteristics, variables, or values, and embodiments of the disclosure according to various embodiments of the disclosure should not be limited by effects such as modifications including limits of tolerances, measurement errors, and measurement accuracy, and other commonly known factors.

In the present specification, when it is described that one component is “connected” or “joined” to another component, it should be understood that the one component may be directly connected or joined to another component, but additional components may be present therebetween. However, when one component is described as being “directly connected,” or “directly coupled” to another component, it should be understood that additional components may be absent between the one component and another component.

In the present specification, when one component is described as being “on” or “facing” another component, it should be understood that the one component may be directly in contact with or connected to another component, but additional components may be present between the one component and another component. Contrarily, when one component is described as being “directly on” or “in direct contact with” another component, it should be understood that there is no additional component between the one component and another component. Other expressions describing the relationship between components, such as “between,” “directly between,” and the like should be interpreted in the same way.

In the present specification, terms such as “first” and “second” may be used to describe various components, but the components should not be limited by the above terms. In addition, the above terms should not be interpreted as limiting the order of each component but may be used for the purpose of distinguishing one component from another. For example, a “first element” could be termed a “second element,” and similarly, a “second element” could also be termed a “first element”.

Unless defined otherwise, all terms used herein may be used in a sense commonly understood by a person having ordinary knowledge in the art to which the disclosure pertains. In addition, it should be understood that terms, such as those defined in commonly used dictionaries, will not be interpreted in an idealized or overly formal sense unless expressly so defined herein.

Below, embodiments of the disclosure will be described in detail with reference to the accompanying drawings.

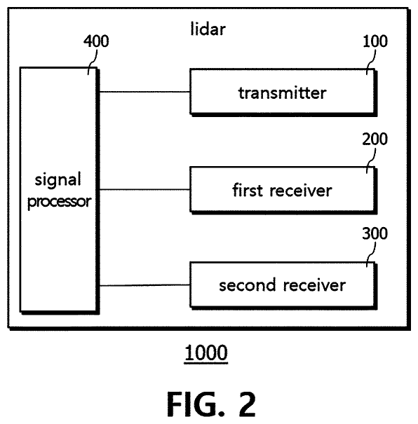

FIG. 2 is a block diagram of a lidar 1000 according to an embodiment of the disclosure.

The lidar 1000 according to an embodiment of the disclosure refers to a sensor device capable of generating information about an object outside a vehicle based on a laser beam to detect the object outside the vehicle. For example, the lidar 1000 may be implemented as a driving or non-driving type. A motor rotates the driving type lidar to detect an object around a vehicle. The non-driving type lidar can detect an object located within a predetermined range with respect to the vehicle by beam steering. In this case, the vehicle may include a plurality of non-driving type lidars.

Further, the lidar 1000 may detect an object based on the time-of-flight (TOF) or phase-shift method using a laser beam and identify the detected object's location, the distance from the detected object, and a relative speed. For example, the lidar 1000 may use a frequency modulation continuous wave (FMCW) type optical signal.

Further, the lidar 1000 may be disposed at an appropriate position of a vehicle to detect objects in front, back or lateral sides of the vehicle. For example, the lidar 1000 may be mounted to the front bumper, radiator grille, hood, roof, windshield, door, side mirror, tailgate, trunk lid, rear bumper, or fender of the vehicle but is not limited thereto.

In this case, the vehicle may be an autonomous vehicle or may include an advanced driver assistance system (ADAS), etc., and perform an autonomous driving operation, a driver assisting operation, etc. based on the information detected by the lidar 1000.

In particular, as shown in FIG. 2, the lidar 1000 may include a transmitter 100, a first receiver 200, a second receiver 300, and a signal processor 400.

The transmitter 100 is configured to generate the FMCW or the like laser beam, and transmit the laser beam to an object. In this case, the transmitter 100 may include a light source to generate the laser beam, and an optical system to adjust the path of the laser beam entering from the light source. For example, the optical system may include various lenses, mirrors, scanners, etc., but is not limited thereto.

The light source may generate laser beams with the same wavelength or different wavelengths. For example, the light source may generate a laser beam having a specific or variable wavelength within a wavelength range of 250 nm to 11 μm, and may be implemented by a small and low-power semiconductor laser diode, but not limited thereto.

The first and second receivers 200 and 300 are configured to receive light reflected from an object. For example, the first and second receivers 200 and 300 may employ a photodiode or the like photoelectric transformation device to transform the light reflected and received from an object into an electric signal (current, etc.). In this case, the light receiving angle of the first and second receivers 200 and 300 may be called a field of view (FOV). Further, the first and second receivers 200 and 300 may include an optical system for adjusting the path of the reflected and received light. For example, the optical system may include various lenses, mirrors, etc., but is not limited thereto.

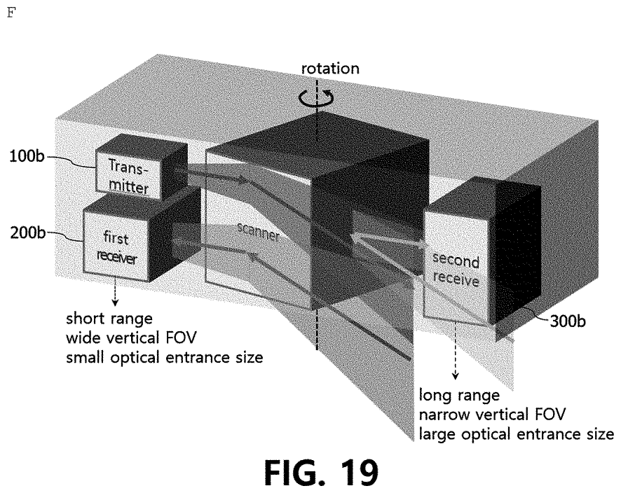

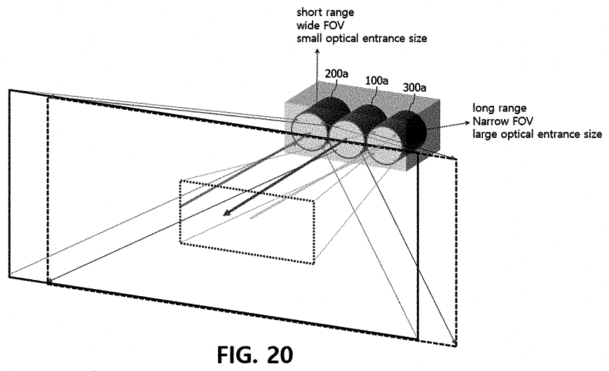

FIG. 19 shows an example of a scanning type scanning lidar. Further, FIG. 20 shows an example of a non-scanning type flash lidar.

Meanwhile, the lidar may be classified into a scanning lidar and a flash lidar according to methods by which the transmitter 100 transmits a laser signal.

In other words, the scanning lidar carries out a scanning method to adjust an optical path by scanning the light. Such a scanning lidar essentially needs a scanner for the scanning, as shown in FIG. 19. Of course, the optical path may be additionally changed by a lens, a mirror, even in the scanning method.

In the scanning type, when a first receiver 200b has a detection region of a short range, a vertical FOV is wide and an optical entrance size is small. Further, when a second receiver 300b has a detection region of a long range, the vertical FOV is narrow and the optical entrance size is large.

On the other hand, the flash lidar measures a distance by separately transmitting laser signals for all measurement directions and then receiving and analyzing reflected waves. Therefore, measurement time increases in proportion to the number of measurement directions. In particular, the flash lidar employs a multi-arrayed receiving device that spreads and transmits the laser signals to the FOV in all measurement directions and measures distances through individual receiving devices like a camera flash, thereby having a constant measurement time regardless of the number of measurement directions because the distances are measured according to the measurement directions. In other words, the flash lidar is of the non-scanning type that does not perform the scanning and changes the optical path by only the lens or mirror and therefore needs no scanner, as shown in FIG. 20.

In the non-scanning type, when a first receiver 200a has a detection region of a short range, a FOV is wide and an optical entrance size is small. Further, when a second receiver 300a has a detection region of a long range, the FOV is narrow and the optical entrance size is large.

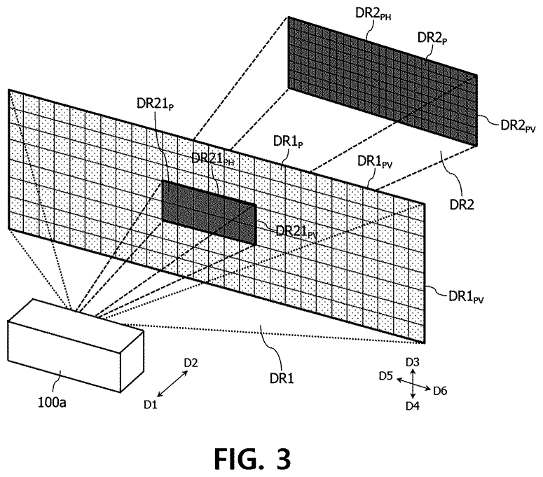

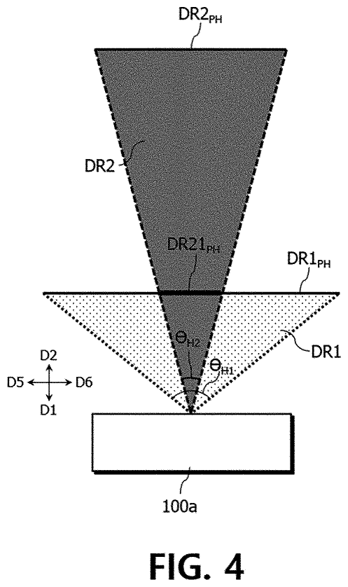

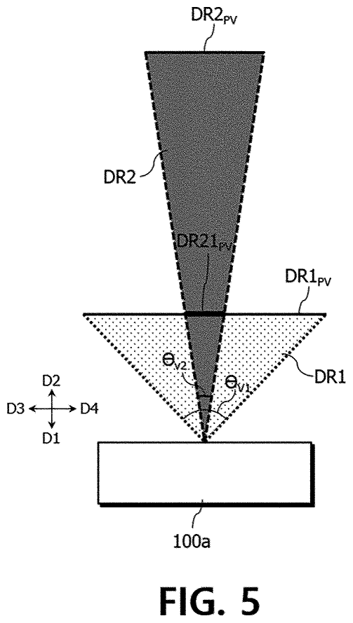

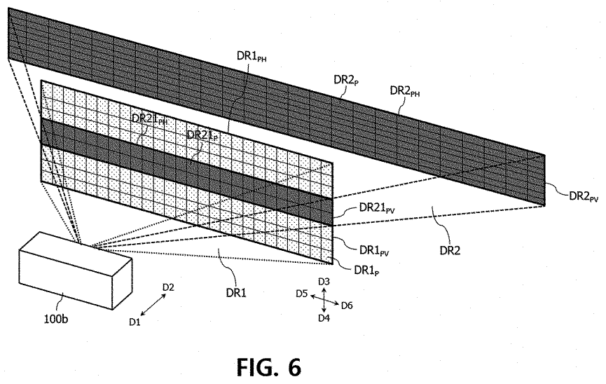

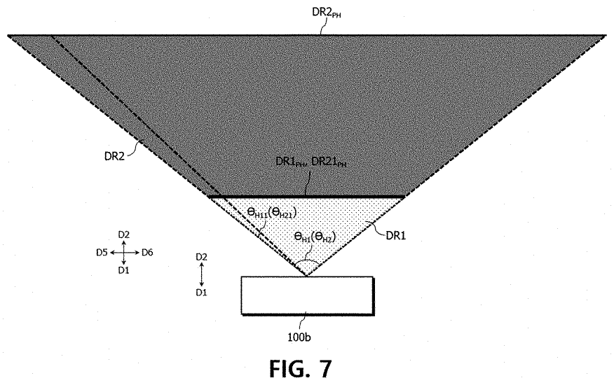

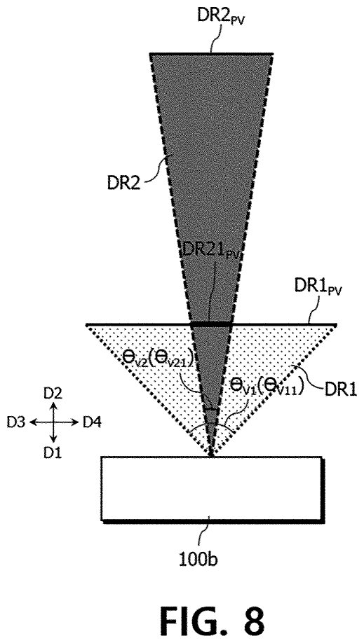

FIG. 3 shows an example of detection regions DR1 and DR2 of a non-scanning type lidar 1000 according to an embodiment of the disclosure, and FIGS. 4 and 5 show the detection regions DR1 and DR2 of FIG. 3, respectively, viewed in horizontal and vertical directions. Further, FIG. 6 shows an example of detection regions DR1 and DR2 of a scanning type lidar 1000 according to an embodiment of the disclosure, and FIGS. 7 and 8 show the detection regions DR1 and DR2 of FIG. 6, respectively, viewed in the horizontal and vertical directions.

However, referring to FIGS. 3 to 8, a first receiver 200 may receive light reflected from an object within a first detection region DR1 of a short range, and a second receiver 300 may receive light reflected from an object within a second detection region DR2 of a long range. In particular, to make the plurality of receivers 200 and 300 receive light transmitted from the single light source and reflected from an object, in other words, to make the plurality of receivers 200 and 300 operate together with regard to one transmitter 100, the transmitter 100 may transmit light so that a two-dimensional region DR21_{P} of the second detection region DR2 projected in the first detection region DR1 can be positioned within the first detection region DR1.

In other words, the detection regions DR1 and DR2 refer to regions formed by the transmitted or reflected light. The first detection region DR1 is the region of the light to be received in the first receiver 200, and the second detection region DR2 is the region of the light to be received in the second receiver 300. In particular, the regions corresponding to the detection regions DR1 and DR2 and projected onto the two-dimensional plane may be called the two-dimensional regions DR1_{P} and DR2_{P}. In particular, DR2_{P} in DR1_{P} may be called DR21_{P}. In this case, the transmitter 100 may transmit light so that DR21_{P} can be included in DR_{P} and, more specifically, in DR1_{P}. Thus, the first and second receivers 200 and 300 may detect a plurality of regions with different specifications (hereinafter referred to as a “plurality of specification effects”). In other words, the first receiver 200 may detect a wider first detection region DR1 of the short range with a specification of a low resolution, and the second receiver 300 may detect a narrower second detection region DR2 of the long range with a specification of a high resolution.

In specific, referring to FIGS. 3 to 5, the non-scanning type, a transmitter 100a may transmit light in a range of vertical and horizontal divergence angles θ_{V1} and θ_{H1} with respect to the first detection region DR1. In this case, the light may be transmitted by gradually spreading in the vertical directions D3 and D4 and in the horizontal directions D5 and D6 within the ranges of the vertical and horizontal divergence angles θ_{V1} and θ_{H1} while traveling.

Thus, the light transmitted in the range of the vertical and horizontal divergence angles θ_{V1} and Gin with regard to the first detection region DR1 and reflected from an object in the short range may be received in the first receiver 200. In this case, the first receiver 200 may include a two-dimensional detection unit to receive the light and generate a signal corresponding to the received light.

In addition, the light transmitted in the range of the narrower vertical and horizontal divergence angles θ_{V2} and θ_{H2} and reflected from an object in the long range, of the light transmitted in the range of the vertical and horizontal divergence angles θ_{V1} and θ_{H1} with respect to the first detection region DR1, may be received in the second receiver 300. Like the first receiver 200, the second receiver 300 may include the two-dimensional detection unit to receive the light and generate a signal corresponding to the light.

As described above, the first and second receivers 200 and 300 have the two-dimensional detection units because the transmitter 100a transmits the light spreading out in the vertical directions D3 and D4 and in the horizontal directions D5 and D6 based on the non-scanning type. In other words, the light transmitted and reflected at a time has a two-dimensionally spreading form.

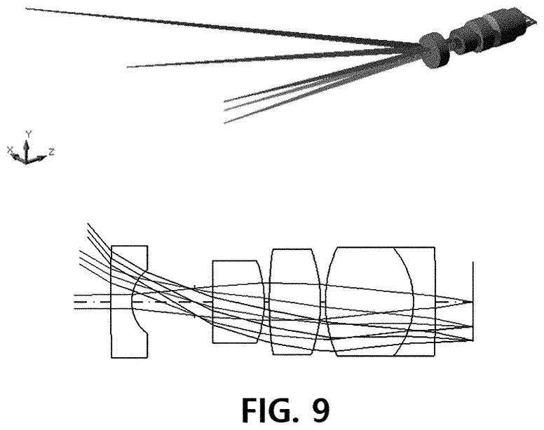

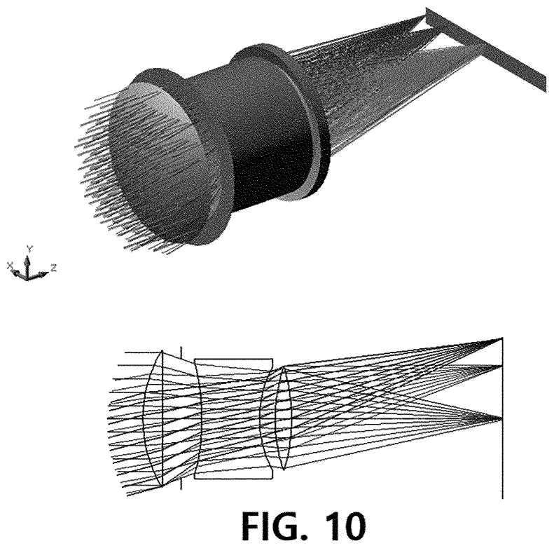

FIG. 9 shows an example of lenses of a first receiver 200 and their optical paths in a non-scanning type lidar 1000 according to an embodiment of the disclosure, and FIG. 10 shows an example of lenses of a second receiver 300 and their optical paths in a non-scanning type lidar 1000 according to an embodiment of the disclosure.

In particular, for the plurality of specification effects, the transmitter 100a may emit light with vertical and horizontal divergence angles θ_{V1} and θ_{H1} wider than or equal to the vertical and horizontal FOV of the first receiver 200. Besides, the lens of the first receiver 200 may have the vertical and horizontal FOV both larger than those of the lens of the second receiver 300. As a result, the vertical and horizontal resolutions of the light received in the first receiver 200 are both higher than those of the light received in the second receiver 300, thereby exhibiting the plurality of specification effects.

For example, referring to FIGS. 9 and 10, when the light is emitted, the transmitter 100a may have a vertical divergence angle θ_{V1} of about 10°, and a horizontal divergence angle θ_{H1} of about 100°. Likewise, for the plurality of specification effects, the first receiver 200 may have a vertical FOV of about 10° and a horizontal FOV of about 100°, and the second receiver 300 may have a vertical FOV of about 3° and a horizontal FOV of about 30°.

Meanwhile, referring to FIGS. 6 to 8, in the case of the one-dimensional scanning type, the transmitter 100b may emit light in the range of the vertical divergence angles θ_{V1} with respect to the first detection region DR1 of the short range while performing the scanning in the horizontal directions D5 and D6. In this case, the emitted light may be gradually spread in the vertical directions D3 and D4 within the range of the vertical divergence angles θ_{V1} while traveling, thereby having an oblong shape, which is longer in the vertical directions D3 and D4 than the horizontal directions D5 and D6 (hereinafter referred to as a “vertically oblong shape”). Then, the light having such a vertically oblong shape may be transmitted while being gradually moved in the horizontal directions D5 and D6 based on the scanning operation of the transmitter 100b.

Thus, the light transmitted in the range of the vertical divergence angles θ_{V1} with regard to the first detection region DR1 and then reflected from an object in the short range may be received in the first receiver 200. In this case, the first receiver 200 may include a one-dimensional detection unit to receive the light and generate a signal corresponding to the received light.

In addition, the light transmitted in the range of narrower vertical divergence angle θ_{V2} and reflected from an object in the long range, of the light transmitted in the range of the vertical divergence angle θ_{V1} with regard to the first detection region DR1, may be received in the second receiver 300. In this case, the second receiver 300 may include a one-dimensional detection unit to receive the light and generate a signal corresponding to the received light.

In FIGS. 7 and 8, θ_{H11} and θ_{H21} indicate the horizontal divergence angles with regard to the first detection region DR1 and the second detection region DR2 when the light having one vertically oblong shape is emitted, and θ_{V11} and θ_{V21} indicate the vertical divergence angles with regard to the first detection region DR1 and the second detection region DR2 when the light has one vertically oblong shape. Further, θ_{H1} and θ_{H2} indicate the horizontal divergence angles with regard to the first detection region DR1 and the second detection region DR2 when the light having the vertically oblong shape is emitted being scanned in the horizontal directions D3 and D4, and θ_{V1} and θ_{V2} indicate the vertical divergence angles with regard to the first detection region DR1 and the second detection region DR2 when the light having the vertically oblong shape is emitted being scanned in the horizontal directions D3 and D4. In this case, θ_{H11} and θ_{H21} are equal, and θ_{H1} and θ_{H2} are equal. Further, θ_{V1} and θ_{V11} are equal, and θ_{V2} and θ_{V21} are equal. Further, θ_{V2} (θ_{V21}) is smaller than θ_{V1} (θ_{V11}).

As described above, the first and second receivers 200 and 300 have the one-dimensional detection units because the transmitter 100b emits the light having the vertically oblong shape and spreading out in the vertical directions D3 and D4 at a time based on the scanning type. In other words, the light transmitted and reflected at a time has a one-dimensionally spreading form based on the vertically oblong shape. Of course, the light having the vertically oblong shape, which is transmitted being gradually moved in the horizontal directions D5 and D6 based on the scanning operation is received in turn in the one-dimensional detection units, and the signal corresponding to the received light is detected based on the reception time interval.

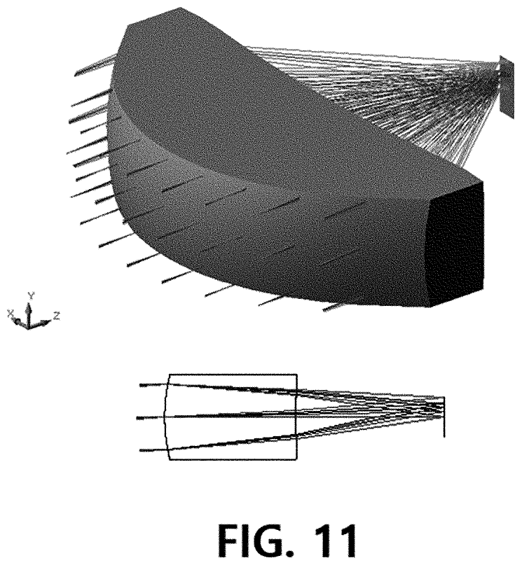

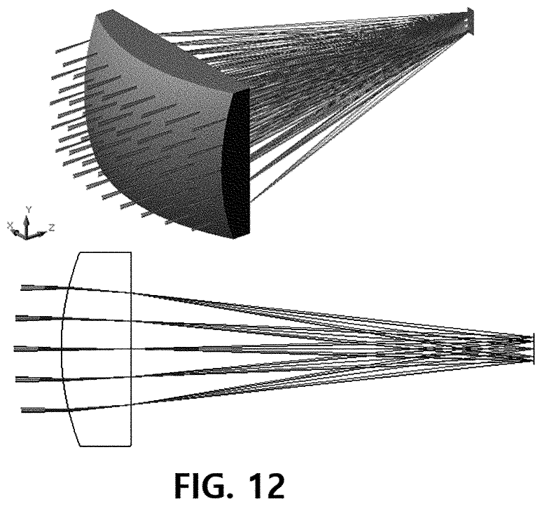

FIG. 11 shows an example of lenses of a first receiver 200 and their optical paths in a scanning type lidar 1000 according to an embodiment of the disclosure, and FIG. 12 shows an example of lenses of a second receiver 300 and their optical paths in a scanning type lidar 1000 according to an embodiment of the disclosure.

For the plurality of specification effects, the transmitter 100b may emit light with vertical divergence angles θ_{V1} wider than or equal to the vertical FOV of the first receiver 200. Besides, the lens of the first receiver 200 may have the vertical FOV larger than that of the lens of the second receiver 300. As a result, a vertical resolution of the light received in the first receiver 200 is lower than that of the light received in the second receiver 300, thereby exhibiting the plurality of specification effects.

In particular, the second receiver 300 may perform detection in a shorter time cycle than the first receiver 200, thereby further increasing the horizontal resolution. In other words, the horizontal resolution may become higher based on an increased repetition rate of the light source. Therefore, it is possible to overcome the limitations of the related art that cannot have a high resolution throughout all regions.

For example, referring to FIGS. 11 and 12, when the light of one vertically oblong shape is emitted, the transmitter 100b has a vertical divergence angle θ_{V1} of about 10° and a horizontal divergence angles θ_{H1} of about 0.2°. Likewise, for the reception of the light having one vertically oblong shape and the plurality of specification effects, the first receiver 200 may have a vertical FOV of about 10°, and a horizontal FOV of about 0.2° and the second receiver 300 may have a vertical FOV of about 3°, and a horizontal FOV of about 0.2°. Further, the first receiver 200 may have a focal length of about 29.2 mm, and the second receiver 300 may have a focal length of about 75 mm longer than that of the first receiver 200. Further, the first receiver 200 may have a smaller optical entrance size (i.e., a smaller entrance pupil size) than the second receiver 300. In this case, the “optical entrance size” refers to an effective size of light that enters the detector.

TABLE 1

| | Non- | | One-dimensional | |
|---|---|---|---|---|
| | scanning type | | scanning type | |
| | First | Second | First | Second |
| | receiver | receiver | receiver | receiver |
| | (Short | (Long | (Short | (Long |
| | range) | range) | range) | range) |
| The number | many | many | few | few |
| of lenses | | | | |
| Optical | small | large | small | Large |
| entrance size | | | | |
| Detector type | 2D array | 2D array | 1D array | 1D array |

| | | |
|---|---|---|
| Effective | < | < |
| focal length | | |
| (Under the | | |
| same | | |
| detector) | | |
| FOV | > | > |

The signal processor 400 is configured to process signals related to the light for the transmitter 100 and the receivers 200 and 300. In other words, the signal processor 400 may include a processor that is electrically connected to the transmitter 100 and the receivers 200 and 300, processes the received signals, and generates data about an object based on the processed signals. In this case, the signal processor 400 may collect and process data based on the light, thereby calculating a distance from the object.

For example, the signal processor 400 may convert an output signal detected in the detectors of the receivers 200 and 300 into a voltage, amplify the signal, and then convert the amplified signal into a digital signal through an analog-to-digital converter (ADC), a time-digital converter (TDC), etc. Further, the signal processor 400 may apply signal processing to changed data through a time-of-flight (TOF) method, a phase-shift method, thereby detecting a distance from an object, the shape of the object, etc.

In this case, the TOF method refers to a method that measures the time taken for laser pulse signals emitted by the transmitter 100 reflected from an object within the detection range to arrive at each of the receivers 200 and 300, thereby measuring the distance from the object. Further, the phase-shift method refers to a method that measures the amount of phase shift of a signal reflected and returning from an object within the detection range after the transmitter 100 emits a laser beam continuously modulated at a specific frequency, thereby calculating a corresponding time and a separating distance.

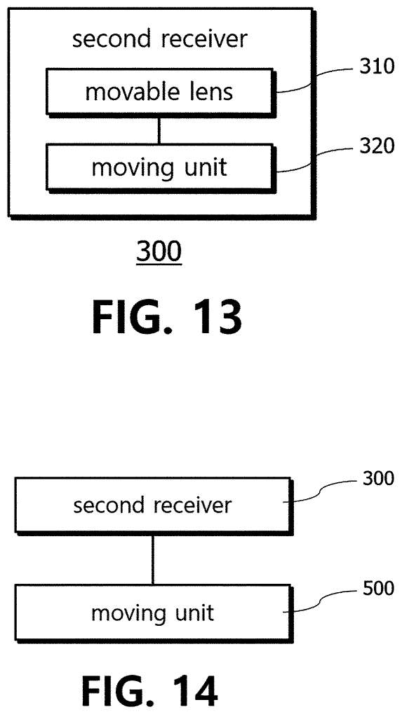

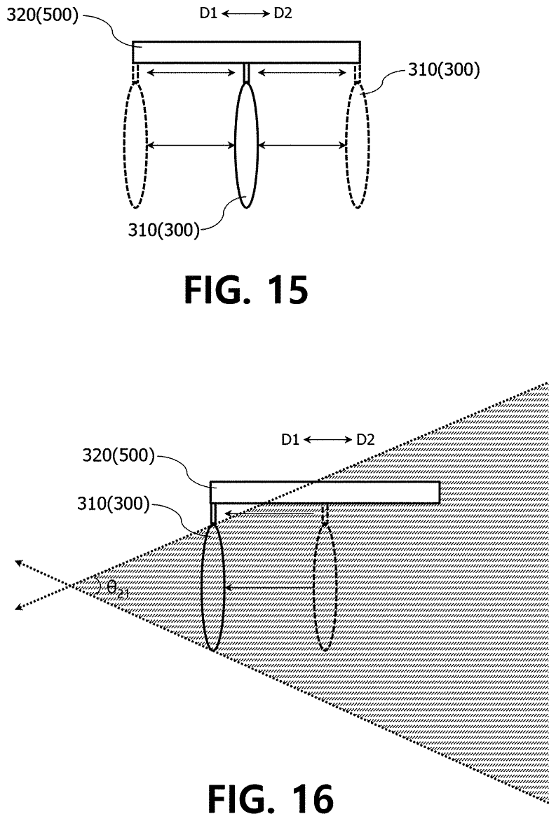

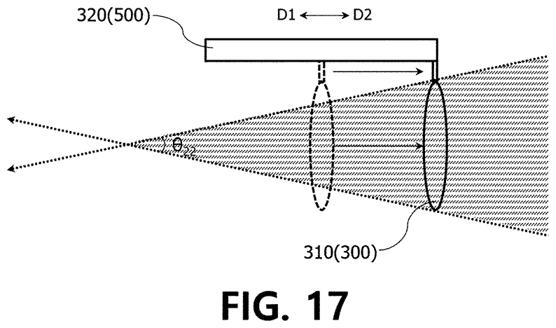

FIG. 13 is a block diagram of a second receiver 300 with a movable lens, and FIG. 14 is a block diagram of a movable second receiver 300. FIG. 15 shows an example of movement of a second receiver 300 or its lens 310, FIG. 16 shows an example of movement of a second receiver 300 or its lens 310 in a light entering direction D1, and FIG. 17 shows an example of the movement of a second receiver 300 or its lens 310 in an opposite direction D2 to the light receiving direction D1.

Meanwhile, the position or angle of the second receiver 300 (or the position or angle of its lens) may be adjustable, and it is, therefore, possible to change the second detection region DR2, i.e., change the size or location of the second detection region DR2. However, even in the case of the changed second detection region DR2, the two-dimensional region DR21_{P} of the second detection region DR2 at least partially overlapping the first detection region DR1 is included in the first detection region DR1, and therefore the plurality of specification effects are continuously maintained.

For example, referring to FIGS. 13 and 15, the second receiver 300 includes a movable lens 310 and a moving unit 320, so that the position or angle of the lens 310 can be changed by the moving unit 320. Alternatively, referring to FIGS. 14 and 15, the second receiver 300 may be connected to a moving unit 500, and changed in position or angle by the moving unit 500. With such a change in position or angle, the FOV (i.e., the detection region) of the second receiver 300 is variable.

The lens 310 includes a movable frontward and backward lens with respect to the direction of light (e.g., in the directions D1 and D2, or the direction of a first axis formed by D1 and D2), thereby having a zoom function. The lens 310 is not specially limited and may, for example, include various lenses such as a convex lens and a concave lens.

The moving unit 320, 500 may be connected to the lens 310 or the second receiver 300, providing power to move the lens 310 or the second receiver 300 itself. For example, the moving unit 320, 500 may include not only various motors or the like actuators but also a general zoom device (or a manual zoom) or the like for frontward and backward movements based on the rotation of a screw.

Further, the second receiver 300 may further include various types of lenses disposed in front/back of the lens 310 and spaced apart from the lens 310.

Referring to FIG. 15, the second receiver 300 or its lens 310 may move in a direction D1 opposite to a light-emitting direction D2, i.e., along a light entering direction D1. In this case, the second receiver 300 may be increased in its FOV θ₂₁, and may also be increased in optical noise and the FOV per pixel. In other words, DR2 and DR21_{PH} become wider, and the resolution becomes lower, thereby increasing the detection ranges DR2_{PH} and DR2_{PV}.

Referring to FIG. 16, the second receiver 300 or its lens 310 may move in a direction D2 opposite to the light entering direction D1. In this case, the second receiver 300 decreases in the FOV θ₂₂ and also decreases in the optical noise and the FOV per pixel. In other words, DR2 and DR21_{PH} become narrower, and therefore the resolution becomes higher, thereby decreasing the detection ranges DR2_{PH} and DR2_{PV}.

Further, the moving unit 320, 500 may implement a function of aligning the angled second receiver 300 or its lens 310 or intentionally changing the angle of the second receiver 300 or its lens 310 (hereinafter referred to as an “additional function”), in addition to the foregoing zoom function. The moving unit 320, 500 may include various actuators in this case. In other words, each of the moving units 320 and 500 may include a first actuator for moving the receiver 300 or its lens 310 frontward or backward with respect to the direction of the light, and the second actuator for rotating the receiver 300 or its lens 310 with respect to a plurality of axes, and may also include an actuator into which the first and second actuators are integrated.

Below, the configuration of the second receiver 300 added for performing the additional functionality will be described by example. For the convenience of description, it will be described that this configuration performs the additional function for the lens 310 of the second receiver 300. Besides, this configuration may be used to perform the additional function for the second receiver 300 itself, and the lens 310 in this case, may refer to the second receiver 300.

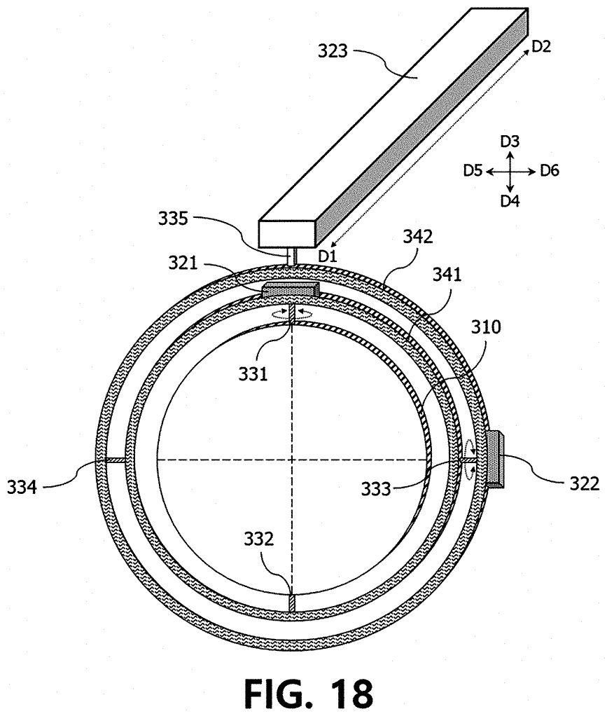

FIG. 18 shows an example of a configuration of a second receiver 300 with a lens that is not only movable but also changeable in angle.

Referring to FIG. 18, to carry out both the zoom function and the additional function, the second receiver 300 includes first and second rotary shafts 331 and 332 rotatable with respect to a second axis, third and fourth rotary shafts 333 and 334 rotatable with respect to a third axis, a moving shaft 335 movable in frontward and backward directions D1 and D2, and first and second structures 341 and 342 shaped like rings formed with openings. In this case, the second and third axes form an angle greater than an acute angle therebetween, and are preferably orthogonal to each other. Further, the second and third axes form an angle greater than an acute angle with the first axis (i.e., the axis formed by D1 and D2), and are preferably orthogonal to the first axis. For example, without limitations, the second axis may be an axis formed by D3 and D4, and the third axis may be an axis formed by D5 and D6.

Specifically, the first structure 341 has an inner space opened having a larger diameter than the movable lens 310 so that the lens 310 can be positioned in the inner space. Further, the first and second rotary shafts 331 and 332 connected to the outside of the lens 310 are connected to the inside of the first structure 341. In this case, the first and second rotary shafts 331 and 332 may be disposed facing each other with the lens 310 delete in the direction of the second axis.

Further, the second structure 342 has an inner space opened having a larger diameter than the first structure, so that the first structure 341 can be positioned in the inner space. Further, the third and fourth rotary shafts 333 and 334 connected to the outside of the first structure 341 are connected to the inside of the second structure 342. In this case, the third and fourth rotary shafts 333 and 334 may be disposed facing each other with the first structure 341 in the direction of the third axis.

Meanwhile, the moving unit 320 may include first to third actuators 321, 322, and 323. In other words, the first actuator 321 provides power for rotating the first rotary shaft 331 or the second rotary shaft 332 with respect to the second axis. As a result, the lens 310 is rotatable with respect to the second axis.

The second actuator 322 provides power for rotating the third rotary shaft 333 or the fourth rotary shaft 334 with respect to the third axis. As a result, the lens 310 is rotatable with respect to the third axis.

The third actuator 323 provides power for moving the moving shaft 335. In other words, the third actuator 323 moves the second structure 342, frontward and backward (D1 and D2), with respect to the direction of light. As a result, the lens 310 is movable along the first axis.

In other words, the first and second actuators 321 and 322 may perform the additional function, and the third actuator 323 may perform the zoom function. For example, without limitations, the first and second actuators 321 and 322 may include various motors for rotating motion, and the third actuator 323 may include a linear motor for linear motion.

Meanwhile, if there is no need for the zoom function, the moving unit 320 may include only the first and second actuators 321 and 322 without the third actuator 323.

With the foregoing configurations according to the disclosure, a single light source is used for both short range and long range, and one transmitter 100 is used, thereby having an advantage of low manufacturing costs. Further, according to the disclosure, a plurality of receivers 200 and 300 are used for one transmitter 100, so that a plurality of regions can be detected with various specifications, and in particular, a detection region for a long range can be changed, thereby having an advantage of being free to select an appropriate operation as necessary. Further, according to the disclosure, a zoom function may be appliable to the second receiver 300, and, in addition to the zoom function, other functions may be implemented to align the second receiver 300 or its lens 310, which are misaligned by various factors during operation, for direction calibration, or intentionally change the angle of the second receiver 300 or its lens 310, thereby having advantages in that the position change of the second detection region DR2 (i.e., the position change of DR2_{P} and DR21_{P}) and the change in the detection range (i.e., DR2_{PH} and DR2_{PV}) for the second detection region DR2 are possible.

Although specific embodiments of the disclosure have been described above, various modifications can be made without departing from the scope of the disclosure. Therefore, the scope of the disclosure is not limited to the foregoing embodiments, but defined by the appended claims and their equivalents.

DESCRIPTION OF REFERENCE NUMERALS

| | |
|---|---|
| 100: transmitter | 200: first receiver |
| 300: second receiver | 310: movable lens |
| 320, 500: moving unit | 321, 322, 323: actuator |
| 331, 332, 333, 334: rotary shaft | 335: moving shaft |
| 341: first structure | 342: second structure |

What is claimed is:

1. A light detection and ranging (lidar) for detecting outside of a vehicle, the lidar comprising:
a transmitter configured to generate and transmit light;
a first receiver configured to receive light reflected from an object within a first detection region of a short range; and
a second receiver configured to receive light reflected from an object within a second detection region of a long range,
wherein a two-dimensional region of the second detection region at least partially overlapping the first detection region is included in the first detection region.

2. The lidar of claim 1, wherein, in a non-scanning type,
the transmitter transmits light in a range of vertical and horizontal divergence angles with respect to a short-range region,
the first receiver comprises a two-dimensional detection unit to receive the light transmitted in the range of the vertical and horizontal divergence angles with respect to the short-range region and reflected from an object in a short range, and
the second receiver comprises a two-dimensional detection unit to receive light transmitted in a narrower range of vertical and horizontal divergence angles and reflected from an object in a long range, of the light transmitted in the range of the vertical and horizontal divergence angles with respect to the short-range region.

3. The lidar of claim 2, wherein the transmitter transmits light having vertical and horizontal divergence angles wider than or equal to vertical and horizontal fields of view (FOV) of the first receiver.

4. The lidar of claim 2, wherein the first receiver has wider vertical and horizontal FOV and a lower resolution than the second receiver.

5. The lidar of claim 1, wherein, in case of a scanning type,
the transmitter transmits light in a range of vertical divergence angle with regard to a region of a short range while performing scanning in a horizontal direction,
the first receiver comprises a one-dimensional detection unit to receive the light transmitted in the range of the vertical divergence angle with regard to the region of the short range and reflected from an object in a short range, and
the second receiver comprises a one-dimensional detection unit to receive light transmitted in a narrower range of a vertical divergence angle and reflected from an object in a long range, of the light transmitted in the range of the vertical divergence angle with regard to the region of the short range.

6. The lidar of claim 5, wherein the transmitter transmits light having a vertical divergence angle wider than or equal to a vertical field of view (FOV) of the first receiver.

7. The lidar of claim 5, wherein the first receiver has a wider vertical field of view and a lower resolution than the second receiver.

8. The lidar of claim 5, wherein the second receiver performs detection in a shorter time cycle than the first receiver to increase a horizontal resolution.

9. The lidar of claim 1, wherein the second receiver is adjustable in position or angle of a lens thereof to change the second detection region.

10. A vehicle with light detection and ranging (lidar) for detecting an outside,
the lidar comprising:
a transmitter configured to generate and transmit light;
a first receiver configured to receive light reflected from an object within a first detection region of a short range; and
a second receiver configured to receive light reflected from an object within a second detection region of a long range,
wherein a two-dimensional region corresponding of the second detection region at least partially overlapping the first detection region is included in the first detection region.

11. The vehicle of claim 10, wherein, in a non-scanning type,
the transmitter transmits light in a range of vertical and horizontal divergence angles with regard to a region of a short range,
the first receiver comprises a two-dimensional detection unit to receive the light transmitted in the range of the vertical and horizontal divergence angles with regard to the region of the short range and reflected from an object in a short range, and
the second receiver comprises a two-dimensional detection unit to receive light transmitted in a narrower range of vertical and horizontal divergence angles and reflected from an object in a long range, of the light transmitted in the range of the vertical and horizontal divergence angles with respect to the short-range region.

12. The vehicle of claim 11, wherein the transmitter transmits light having vertical and horizontal divergence angles wider than or equal to vertical and horizontal fields of view (FOV) of the first receiver.

13. The vehicle of claim 11, wherein the first receiver has wider vertical and horizontal fields of view and a lower resolution than the second receiver.

14. The vehicle of claim 10, wherein, in case of a scanning type,
the transmitter transmits light in a range of vertical divergence angle with regard to a region of a short range while performing scanning in a horizontal direction,
the first receiver comprises a one-dimensional detection unit to receive the light transmitted in the range of the vertical divergence angle with regard to the region of the short range and reflected from an object in a short range, and
the second receiver comprises a one-dimensional detection unit to receive light transmitted in a narrower range of a vertical divergence angle and reflected from an object in a long range, of the light transmitted in the range of the vertical divergence angle with regard to the region of the short range.

15. The vehicle of claim 14, wherein the transmitter transmits light having a vertical divergence angle wider than or equal to a vertical field of view (FOV) of the first receiver.

16. The vehicle of claim 15, wherein the first receiver has a wider vertical field of view and a lower resolution than the second receiver.

17. The vehicle of claim 15, wherein the second receiver performs detection in a shorter time cycle than the first receiver to increase a horizontal resolution.

18. The vehicle of claim 10, wherein the second receiver is adjustable in position or angle of a lens thereof to change the second detection region.

19. The vehicle of claim 10, wherein the lidar is configured to detect an object located in front, back or lateral sides of the vehicle.

20. The vehicle of claim 10, wherein the vehicle comprises an autonomous vehicle or a vehicle with an advanced driver assistance system (ADAS).
